(19) United States
(12) Patent Application Publication
(10) Pub. No.: US 2024/0394629 A1
(43) Pub. Date: Nov. 28, 2024

(54) RECOMMENDATION SYSTEM AND OPERATION METHOD THEREOF

(71) Applicants: Digiwin Software Co., Ltd, Shanghai (CN); DATA SYSTEMS CONSULTING CO., LTD., New Taipei City (TW)

(72) Inventors: Wenliang Bi, Shanghai (CN); Guoxin Sun, Shanghai (CN)

(73) Assignees: Digiwin Software Co., Ltd, Shanghai (CN); DATA SYSTEMS CONSULTING CO., LTD., New Taipei City (TW)

(21) Appl. No.: 18/351,468

(22) Filed: Jul. 12, 2023

(30) Foreign Application Priority Data
May 24, 2023 (CN) 202310594373.5

(51) Int. Cl. G06Q 10/0631; G06F 16/908; G06Q 10/0633

(52) U.S. Cl. CPC G06Q 10/06316; G06F 16/908; G06Q 10/0633

(57) ABSTRACT

A recommendation system and an operation method thereof are provided. The recommendation system includes a storage device and a processor. The storage device stores an enterprise database of an enterprise system. The processor executes a plurality of modules in the storage device. A user profile building module and a task profile building module perform data mining according to historical behavior information, user information and task information in the enterprise database to generate user profile data and task profile data. The profile matching module performs data mining according to the historical behavior information, the user profile data, and the task profile data to generate a profile knowledge map, so that when the enterprise system 10 receives input information, the enterprise system obtains recommended data that matches the input information from the user profile data, the task profile data, and the profile knowledge map, so as to improve work efficiency.

### CROSS-REFERENCE TO RELATED APPLICATION

This application claims the priority benefit of China application serial no. 202310594373.5, filed on May 24, 2023. The entirety of the above-mentioned patent application is hereby incorporated by reference herein and made a part of this specification.

### BACKGROUND

### Technical Field

The disclosure relates to an electronic system, and particularly relates to a recommendation system using data mining and an operation method thereof.

### Description of Related Art

Generally, an enterprise service platform may be applied in an enterprise to provide various business services of the enterprise. However, along with development of the enterprise, service projects are also diversified, making it difficult for users to effectively experience the required services when operating the enterprise service platform. For example, for new employees, in order to use the enterprise service platform to complete their works correctly and quickly, the new employees must consult other colleagues on the operation of the enterprise service platform, thereby reducing work efficiency.

### SUMMARY

The disclosure is directed to a recommendation system capable of building structured data of a profile to provide intelligent recommendations and improve work efficiency.

According to an embodiment of the disclosure, the recommendation system of the disclosure includes a storage device and a processor. The storage device stores multiple modules and accesses an enterprise database of an enterprise system. The modules include a user profile building module, a task profile building module and a profile matching module. The processor is coupled to the storage device. The processor executes the modules. The user profile building module and the task profile building module perform data mining according to historical behavior information, user information and task information in the enterprise database to generate user profile data and task profile data. The profile matching module performs data mining according to the historical behavior information, the user profile data, and the task profile data to generate a profile knowledge map, so that when the enterprise system receives input information, the enterprise system obtains recommended data that matches the input information from the user profile data, the task profile data, and the profile knowledge map.

According to an embodiment of the disclosure, the operation method of the recommendation system of the disclosure includes following steps. A storage device is used to store multiple modules and access an enterprise database of an enterprise system. The modules include a user profile building module, a task profile building module and a profile matching module. A processor is used to execute the modules to perform following steps. The user profile building module and the task profile building module are used to perform data mining according to historical behavior information, user information and task information in the enterprise database to generate user profile data and task profile data. The profile matching module is used to perform data mining according to the historical behavior information, the user profile data, and the task profile data to generate a profile knowledge map, so that when the enterprise system receives input information, the enterprise system obtains recommended data that matches the input information from the user profile data, the task profile data, and the profile knowledge map.

Based on the above description, the recommendation system and the operation method thereof of the disclosure perform data mining through multiple modules to generate the profile knowledge map based on the user profile data and the task profile data, which may build structured data between the user profile data and the task profile data. In this way, the enterprise system may provide a recommendation result associated with the user or task based on the structured data, and assist the user to operate the enterprise system, thereby improving work efficiency.

To make the aforementioned more comprehensible, several embodiments accompanied with drawings are described in detail as follows.

### BRIEF DESCRIPTION OF THE DRAWINGS

FIG. 1 is a circuit block diagram of a recommendation system according to an embodiment of the disclosure.

FIG. 2 is a flowchart of an operation method of a recommendation system according to an embodiment of the disclosure.

FIG. 3 is a schematic diagram of an operation of a recommendation system according to another embodiment of the disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

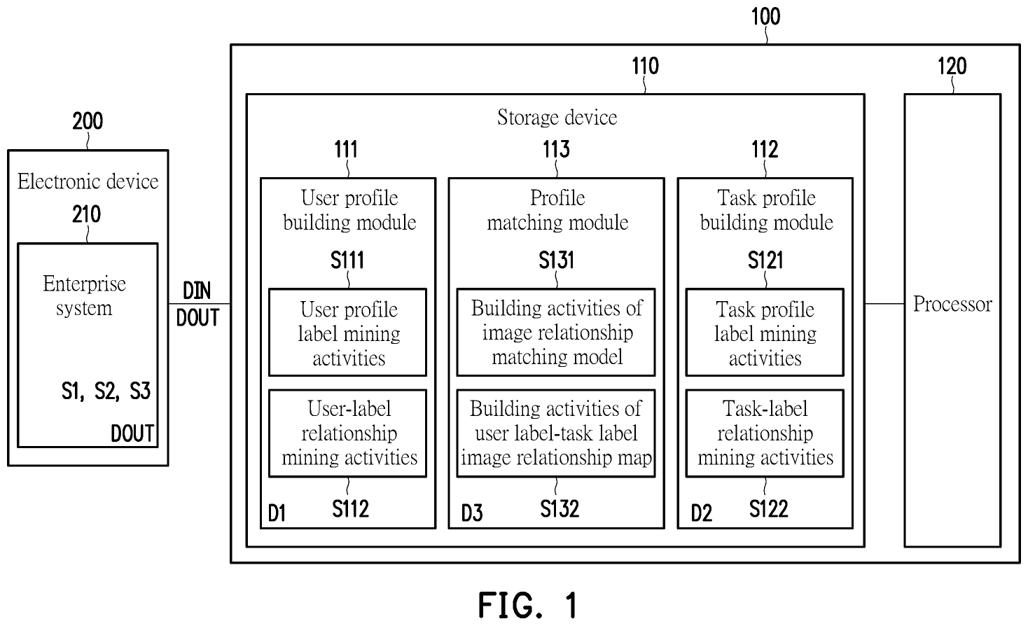

FIG. 1 is a circuit block diagram of a recommendation system according to an embodiment of the disclosure. Referring to FIG. 1, a recommendation system 100 applies data mining to build multiple sets of structured data (such as a profile knowledge map D3) according to various data in an enterprise system. In the embodiment, the recommendation system 100 may be applied to the manufacturing industry, so that the enterprise system used by the manufacturing industry may generate recommended data based on the recommendation system 100.

In the embodiment, the recommendation system 100 is coupled to an electronic device 200. The electronic device 200 may operate a user interface to execute the recommendation system 100 through an application programming interface (API), and then obtain a result of API calling through the recommendation system 100. For example, the electronic device 200 operates the recommendation system 100 according to input information DIN through the API calling, so as to obtain an intelligent recommendation results (i.e., recommended data DOUT) in a manufacturing scenario application.

In the embodiment, the electronic device 200 may also operate the user interface to execute an enterprise system 210 through the API, and then execute various business services through the enterprise system 210. For example, the electronic device 200 operates the enterprise system 210 through API calling, so as to realize various functions in a manufacturing scenario application (such as signing a purchase order). The enterprise system 210 may be, for example, an enterprise resource planning (ERP) system. The electronic device 200 may be, for example, a mobile phone, a tablet computer, a notebook computer, a desktop computer, etc.

In the embodiment, the recommender system 100 may be set in cloud for users to connect through the electronic device 200 and execute related business service functions (for example, related functions of the ERP system) of different APIs that are also set in the recommender system 100. The recommendation system 100 may be, for example, a software as a service (SaaS) server, which executes a corresponding SaaS application through the API. In some embodiments, the recommender system 100 may be set in a ground end of an enterprise, so that the user may connect the recommendation system 100 with other systems set in the cloud through the electronic device 200 to input/output data, so as to execute the corresponding SaaS applications through the API.

In the embodiment, the recommendation system 100 may include a storage device 110 and a processor 120. The storage device 110 may store multiple modules 111-113. These modules may include a user profile building module 111, a task profile building module 112 and a profile matching module 113. In some embodiments, the storage device 110 may also store a recommendation engine module. In the embodiment, the storage device 110 may access an enterprise database of the enterprise system 210 (the ERP system 210 is taken as an example in the following embodiments). The enterprise database may store user information S1, task information S2 and historical behavior information S3.

In the embodiment, the user information S1 may be, for example, identity-related basic information of any tenant such as an account name, a company category, a company account, etc., as well as identity-related basic information of a company, a department, a function, and a supervisor, etc., of any user under a certain tenant, or a combined user basic information thereof. In the embodiment, the task information S2 may be, for example, any related serial operations for realizing various business behaviors (or business functions), and information of any task or a combination thereof. In the embodiment, the historical behavior information S3 may be, for example, any user or task's logfile, transaction data, data trace, and microservice logs, or information of a combination thereof.

In the embodiment, the storage device 110 may also store relevant algorithms, calculation software, etc., of each of the module 111-113 to implement relevant algorithms, programs and data related to functions such as data mining, data labelling, data classification, various calculations, and model training of the disclosure. The storage device 110 may be, for example, a dynamic random access memory (DRAM), a flash memory, a non-volatile random access memory (NVRAM) or a combination of these memories.

In the embodiment, the processor 120 is coupled to the storage device 110. The processor 120 may access the storage device 110, and may execute data, various modules 111-113 in the storage device 110, and access data (for example, information S1-S3) from the ERP system 210 through the electronic device 200. In the embodiment, the processor 120 may be, for example, a signal converter, a field programmable gate array (FPGA), a central processing unit (CPU), or other programmable general-purpose or special-purpose microprocessor, digital signal processor (DSP), programmable controller, application specific integrated circuits (ASIC), programmable logic device (PLD) or other similar device or a combination of these devices, which may load and execute computer program-related firmware or software to realize functions such as data mining, data labelling, data classification, various calculations, model training and execution, etc.

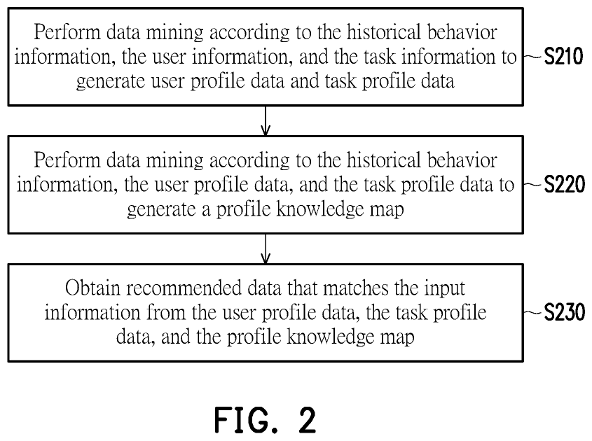

FIG. 2 is a flowchart of an operation method of a recommendation system according to an embodiment of the disclosure. Referring to FIG. 1 and FIG. 2, the recommendation system 100 may execute steps S210-S230. An order of these steps S210-S230 is only an example for illustration, and the disclosure is not limited thereto.

In step S210, the processor 120 executes the user profile building module 111 and the task profile building module 112, so that the user profile building module 111 and the task profile building module 112 may perform data mining according to the historical behavior information S3, the user information S1 and the task information S2 in the enterprise database to generate user profile data D1 and task profile data D2.

In the embodiment, the user profile data DI may be, for example, data related to user profiles of multiple users in the ERP system 210. The task profile data D2 may be, for example, data related to task profiles of multiple tasks in the ERP system 210.

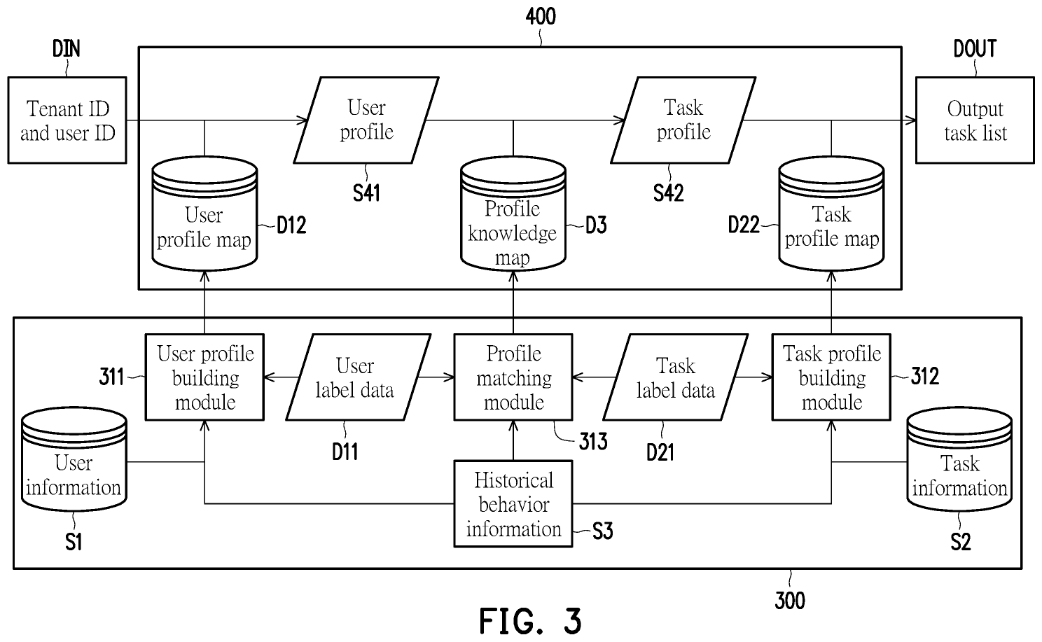

In detail, the user profile building module 111 may build the user profile data DI by executing modules S111-S112. In the module S111, the user profile building module 111 performs user profile label mining activities according to the historical behavior information S3 to generate a set of various user labels (for example, user label data D11 shown in FIG. 3) about business behaviors (or business functions) corresponding to users in the user profile data D1. In the module S112, the user profile building module 111 performs user-label relationship mining activities according to the user information S1 and the above set of user labels, so as to generate structured data (for example, a user profile map D12 shown in FIG. 3) related to the relationship between the user labels and the users in the user profile data D1.

Continuing with the above description, the task profile building module 112 may execute modules S121-S122 to build the task profile data D2. In the module S121, the task profile building module 112 executes task profile label mining activities according to the historical behavior information S3 to generate a set of various task labels (for example, task label data D21 shown in FIG. 3) about business behaviors (or business functions) corresponding to tasks in the task profile data D2. In the module S122, the task profile building module 112 performs task-label relationship mining activities according to the task information S2 and the above set of task labels, so as to generate structured data (for example, a task profile map D22 shown in FIG. 3) related to the relationship between the task labels and the tasks in the task profile data D2.

In step S220, the processor 120 executes the profile matching module 113, so that the profile matching module 113 performs data mining according to the historical behavior information S3, the user profile data DI and the task profile data D2 to generate a profile knowledge map D3.

In the embodiment, the profile knowledge map D3 may include structured data related to the relationship between the user profile data DI and the task profile data D2. Namely, the profile knowledge map D3 may be, for example, data related to the relationship between user profiles corresponding to multiple users and task profiles corresponding to multiple tasks, and may be represented by multiple structured data.

In detail, the profile matching module 113 may execute modules S131-S132 to build the profile knowledge map D3. In the module S131, the profile matching module 113 executes building activities of an image relationship matching model according to the historical behavior information S3, so as to build and train a matching model for matching the relationship between the user labels and the task labels through cluster analysis and association analysis. In the module S132, the profile matching module 113 executes building activities of a user label-task label image relationship map according to the user profile data D1 and the task profile data D2, so as to build the structured data (i.e., the profile knowledge map D3) of the relationship between the user profile and the task profile through the trained matching model (i.e., the profile knowledge map D3).

In the embodiment, after the recommendation system 100 completes building the profile knowledge map D3, the recommendation system 100 may cooperate with the electronic device 200 to proceed to step S230. In such application scenario, the electronic device 200 may operate the ERP system 210 to obtain the corresponding intelligent recommendation result (i.e., the recommended data DOUT) based on the input information DIN and the recommendation system 100.

In step S230, when the ERP system 210 receives the input information DIN, the ERP system 210 executes the recommendation engine module, so that the recommendation engine module obtains the recommended data DOUT that matches the input information from the user profile data D1, the task profile data D2, and the profile knowledge map D3.

In the embodiment, the recommended data DOUT may be, for example, multiple executable tasks matched to the user, and presented in the user interface of the electronic device 200 as a task list. Alternatively, the recommended data DOUT may be, for example, multiple authorized users matching the business behavior (or business function), and presented in the user interface of the electronic device 200 as a user list.

It should be noted that by using the modules 111-113 to perform data mining to respectively build the user profile data D1, the task profile data D2, and the profile knowledge map D3, data related to users, tasks, and business behaviors (or business functions) in the ERP system 210 may be formulated and managed systematically, and may be expressed in structured data. In this way, based on the aforementioned data and the user's current operation scenario, the ERP system 210 and the recommendation system 100 may cooperate to push the recommended data DOUT such as the most relevant task list or user list, etc. Therefore, the user does not need to rashly ask other colleagues about a workflow, but may use the recommendation system 100 to assist the user to operate the enterprise system, thereby improving work efficiency and user experience.

FIG. 3 is a schematic diagram of an operation of a recommendation system according to another embodiment of the disclosure. Referring to FIG. 3, a recommendation system 300 is coupled to an electronic device 400. The recommendation system 300 may include a user profile building module 311, a task profile building module 312 and a profile matching module 313 stored in a storage device, and a processor used for executing these modules 311-313. Regarding the recommendation system 300, the user profile building module 311, the task profile building module 312, and the profile matching module 313, reference may be made to the relevant descriptions of the recommendation system 100 for analogizing. The electronic device 400 may refer to related descriptions of the recommended electronic device 200 for analogizing.

In the embodiment, the user profile building module 311 and the task profile building module 312 may be, for example, respectively implemented by machine learning models. In detail, the user profile building module 311 may include one or multiple classification models. The classification models may be, for example, a Word2vec model, an xgboost model, or a combination thereof, so as to realize various functions of the user profile building module 311 of the embodiment. In the embodiment, the task profile building module 312 may also include one or multiple classification models. The classification model may be, for example, a one-hot model, a Word2vec model, an xgboost model or a combination thereof, so as to realize various functions of the task profile building module 312 of the embodiment.

In the embodiment, the profile matching module 313 may be, for example, implemented by an explainable machine learning model. In detail, the profile matching module 313 may include one or multiple association analysis models. The association analysis model may be, for example, an Apriori model to realize various functions of the profile matching module 313 of the embodiment.

In the embodiment, the user profile building module 311 builds the user profile data D1 including the user label data D11 and the user profile map D12 according to the historical behavior information S3 and the user information S1. In the embodiment, the user label data D11 may be, for example, user labels such as various attributes and features of the user, and is expressed in a vector structure. The user profile map D12 may be, for example, matching data of the relationship between the users and the user labels, and is expressed in a map structure.

In the embodiment, the user profile building module 311 stores the user label data D11 in a first database. The first database may be, for example, a storage device in the recommendation system 300, or a database externally connected to the recommendation system 300, so that the profile matching module 313 may access the first database. In the embodiment, the user profile building module 311 stores the user profile map D12 in a second database. The second database may be, for example, a storage device in the recommendation system 300, or a database configured in the ERP system, so that the electronic device 400 may access the second database through the ERP system.

In detail, the user profile building module 311 executes log mining according to the historical behavior information S3 to generate the user label data D11, to illustrate operation details of the step S210 and the module S111. Namely, the user profile building module 311 performs data mining on user behavior log files in the historical behavior information S3 to extract a data set (i.e., the user label data D11). In the embodiment, log mining may, for example, apply unsupervised learning calculations to automatically classify the user behavior log files in the historical behavior information S3 and accordingly output the user label data D11.

Continuing with the above description, the user profile building module 311 performs classification calculations according to the user basic information in the user information S1 and the user label data D11 to build the user profile map D12, so as to illustrate the operation details of the step S210 and the module S112. The user profile map D12 may include structured data of the relationship between the user information S1 and the user label data D11. Namely, the user profile building module 311 mines a many-to-many relationship between the users and the user labels (i.e., the user profile map D12) from the extracted data set according to a user profile label building algorithm (i.e., classification calculation). In the embodiment, the classification calculation may, for example, apply unsupervised learning and artificial annotation calculation to process and calculate user basic information and the user label data D11 through data labelling, cluster analysis and the method of artificial annotation, and accordingly output triplet structured data of users, relationships, and user labels (i.e., the user profile map D12).

Specifically, the user profile building module 311 executes basic profile relationship mining activities to execute the following steps, so as to complete building of the user profile map D12. The user profile building module 311 executes the classification model to classify the basic user information represented by text information in the user information S1. The user profile building module 311 executes the classification model to classify abstract labels with feature labels and feature combinations in the user label data D11. The user profile building module 311 labels and annotates a historical user table (for example, a detailed list of all registered users in the ERP system 210) in the user information S1 through the artificial annotation method, so as to generate an annotation table and the user profile map D12. The user profile building module 311 trains the classification model based on the annotation table, so as to update the user profile map D12 synchronously through the trained classification model when a new user is added.

In addition, the user profile building module 311 performs classification calculations according to user interest information in the user label data D11 to update and train the user profile building module 311. Specifically, the user profile building module 311 executes interest profile relationship mining activities to execute the following steps, so as to complete building of the user profile map D12. The user profile building module 311 executes the classification model (such as the Word2vec model) to vectorize and classify the abstract labels represented by unstructured labels in the user label data D11 through natural language processing. The aforementioned abstract labels may, for example, include a label denoted as “more active users at an end of a project” and a label denoted as “following report users”. The user profile building module 311 executes the classification model (such as the xgboost model) to periodically train and update the classification model based on the user interest information, so as to update the user profile map D12.

In the embodiment, the task profile building module 312 builds the task profile data D2 including the task label data D21 and the task profile map D22 according to the historical behavior information S3 and the task information S2. In the embodiment, the task label data D21 may be, for example, task labels such as basic content, various attributes and features of the task, and is expressed in a vector structure. The task profile map D22 may be, for example, matching data of the relationship between the tasks and the task labels, and is expressed in a map structure.

In the embodiment, the task profile building module 312 stores the task label data D21 in a third database. The third database may be, for example, a storage device in the recommendation system 300, or a database externally connected to the recommendation system 300, so that the profile matching module 313 may access the third database. In the embodiment, the task profile building module 312 stores the task profile map D22 in a fourth database. The fourth database may be, for example, a storage device in the recommendation system 300, or a database configured in the ERP system, so that the electronic device 400 may access the fourth database through the ERP system.

In detail, the task profile building module 312 executes log mining according to the historical behavior information S3 to generate the task label data D21, so as to illustrate operation details of the step S210 and the module S121. Namely, the task profile building module 312 performs data mining on task behavior log files in the historical behavior information S3 to extract a data set (i.e., the task label data D21). In the embodiment, the log mining may, for example, apply unsupervised learning calculations to automatically classify the task behavior log files in the historical behavior information S3 and accordingly output the task label data D21.

Continuing with the above description, the task profile building module 312 performs classification calculations according to the task information S2 and the task label data D21 to build the task profile map D22, so as to illustrate the operation details of the step S210 and the module S122. The task profile map D22 may include structured data of the relationship between the task information S2 and the task label data D21. Namely, the task profile building module 312 mines a many-to-many relationship between the tasks and the task labels (i.e., the task profile map D22) from the extracted data set according to a task profile label building algorithm. In the embodiment, the classification calculation may, for example, apply unsupervised learning and artificial annotation calculation to process and calculate the task information S2 and the task label data D21 through data labelling, cluster analysis and the method of artificial annotation, and accordingly output triplet structured data of tasks, relationships, and task labels (i.e., the task profile map D22).

Specifically, the task profile building module 312 executes task-label relationship mining activities to execute the following steps, so as to complete building of the task profile map D22. The task profile building module 312 executes the classification models (for example, the one-hot model and the Word2vec model) to classify the defined feature labels and abstract labels abstracted based on task behaviors in the task label data D21. The aforementioned abstract labels may, for example, include a label denoted as “tasks of more concern at the end of the project” and a label denoted as “must-see report at the end of sprint”. The task profile building module 312 labels and annotates a historical task table (for example, a detailed list of all defined tasks in the ERP system 210) in the task information S2 through the artificial annotation method, so as to generate an annotation table and the task profile map D22. The task profile building module 312 trains the classification model based on the annotation table. The task profile building module 312 executes the classification model (such as the xgboost model) to periodically train and update the classification model based on the latest task information S2, and accordingly updates the task profile map D22.

In the embodiment, the profile matching module 313 executes data annotation to generate user and task preference data according to the user profile map D12, the task profile map D22 and the historical behavior information S3, so as to illustrate the operation details of the step S220 and the module S131. Namely, based on the user profile map D12 and the task profile map

D22, the profile matching module 313 scores the user's preference behavior for the tasks in the historical behavior information S3 through data annotation. In the embodiment, data annotation may, for example, apply unsupervised learning and artificial annotation calculation to process and calculate the historical behavior information S3 through data labelling, cluster analysis and the artificial annotation method, and accordingly output correlation between the user and the task behavior (i.e., the user and task preference data). If the user and task preference data have a higher score value, it may indicate that the user has a higher degree of preference for the task.

In the embodiment, the user's preference behavior for a task may include, for example, performing a behavior such as “click”, “enter”, “submit”, and “close”, and retaining “click”, “enter”, and “submit” for a certain task, and the corresponding score (i.e., a score value of the user and task preference data) may be, for example, “1 point”. The user's preference behavior for a task may, for example, include performing a behavior of “click without other operations” for a certain task, and the corresponding score may be, for example, “1 point”. The user's preference behavior for a task may, for example, include performing a behavior of “opening for operation but not submitting” for a certain task, and the corresponding score may be, for example, “2 points”. The user's preference behavior for a task may, for example, include performing a behavior of “opening, performing an operation and submitting” for a certain task, and the corresponding score may be, for example, “3 points”.

In the embodiment, the profile matching module 313 performs association analysis according to the user profile map D12, the task profile map D22, and the user and task preference data to build the profile knowledge map D3, so as to illustrate the operation details of the step S220 and the module S132. Namely, the profile matching module 313 analyzes an association relationship between the user profile map D12 and the task profile map D22 based on the user and task preference data to generate the profile knowledge map D3.

Specifically, the profile matching module 313 performs the following steps to complete building of the profile knowledge map D3. The profile matching module 313 performs data pre-processing through data cleaning, so as to remove error records and useless information from the user profile map D12 and the task profile map D22 respectively, and retain valid information. The profile matching module 313 executes an association analysis model (such as an Apriori model) to calculate a confidence between the respective map data in the user profile map D12 and the task profile map D22. The profile matching module 313 executes the association analysis model to generate a user profile-task profile matching pair to serve as triplet structured data between user profile, preference (or concern), and task profile when the confidence meets a corresponding default value (i.e., the user and task preference data).

In some application scenarios, after the recommendation system 300 has finished building the maps D12, D22 and D3, the electronic device 400 may obtain the corresponding recommended data DOUT based on the input information DIN and the recommendation system 300, to illustrate the operation details of the step S230.

In the embodiment, the input information DIN may be, for example, information represented as “tenant ID and user ID”, to indicate that a specific user under a specific tenant operates the electronic device 400 in the ERP system. At this point, the electronic device 400 executes r recommendation engine module to call the user profile map D12, the task profile map D22 and the profile knowledge map D3 through the API. The recommendation engine module retrieves a user profile S41 (for example, a profile represented as “accountant”) that matches the input information DIN from the user profile map D12 based on the input information DIN. Based on the user profile S41, the recommendation engine module retrieves a task profile S42 that matches the user profile S41 and has explainable descriptions (for example, profiles represented as “storage” and “sign-off”) from the profile knowledge map D3. Based on the task profile S42, the recommendation engine module retrieves one or more task profiles matching the task profile S42 from the task profile map D22 to serve as the recommended data DOUT. The recommended data DOUT may be, for example, information denoted as “output task list” and include sorted or unsorted recommended tasks.

In some embodiments, the input information DIN may be replaced by the recommended data DOUT shown in FIG. 3 to represent as information of “output task list”. At this time, the electronic device 400 executes the recommendation engine module to obtain the recommended data DOUT expressed as “tenant ID and user ID” based on the input information DIN. Regarding the operation of the recommendation engine module, reference may be made to the relevant description of the above-mentioned recommendation engine module for analogizing.

In the embodiment, the recommendation engine module may be, for example, implemented by software or firmware. In detail, the recommendation engine module may include a presentational state transfer (REST) API, a software development kit (SDK) or a combination thereof to call the maps D12, D22 and D3 in the recommendation system 300. The recommendation engine module may also include a Neo4j database to store the accessed data.

In summary, the recommendation system and the operation method thereof of the disclosure perform data mining and classification calculations on the information in the ERP system to build multiple structured profile maps, which may combine applications of the manufacturing industry to mine a profile relationship map (i.e. the profile knowledge map) between the user profile and the task profile. Therefore, the ERP system may push the most relevant and explainable recommended tasks or recommended principal (i.e., recommended data) based on the profile knowledge map, so as to prevent users from rashly asking other colleagues about the workflow, thereby improving work efficiency.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A recommendation system, comprising:
a storage device, storing a plurality of modules and accessing an enterprise database of an enterprise system, wherein the modules comprise a user profile building module, a task profile building module, and a profile matching module; and
a processor, coupled to the storage device, and executing the modules,
wherein the user profile building module and the task profile building module perform data mining according to historical behavior information, user information, and task information in the enterprise database to generate user profile data and task profile data,
wherein the profile matching module performs data mining according to the historical behavior information, the user profile data, and the task profile data to generate a profile knowledge map, so that when the enterprise system receives input information, the enterprise system obtains recommended data that matches the input information from the user profile data, the task profile data, and the profile knowledge map.

2. The recommendation system according to claim 1, wherein the profile knowledge map comprises structured data of a relationship between the user profile data and the task profile data.

3. The recommendation system according to claim 1, wherein the user profile data comprises user label data and a user profile map,
wherein the user profile building module stores the user label data in a first database, so that the profile matching module accesses the first database, and stores the user profile map in a second database, so that the enterprise system accesses the second database.

4. The recommendation system according to claim 1, wherein the user profile building module performs log mining according to the historical behavior information to generate user label data in the user profile data.

5. The recommendation system according to claim 4, wherein the user profile building module performs classification calculation according to user basic information in the user information and the user label data to build a user profile map in the user profile data, wherein the user profile map comprises structured data of a relationship between the user information and the user label data.

6. The recommendation system according to claim 4, wherein the user profile building module performs classification calculation according to user interest information in the user label data to train and update the user profile building module.

7. The recommendation system according to claim 1, wherein the task profile data comprises task label data and a task profile map,
wherein the task profile building module stores the task label data in a third database, so that the profile matching module accesses the third database and stores the task profile map in a fourth database, so that the enterprise system accesses the fourth database.

8. The recommendation system according to claim 1, wherein the task profile building module executes log mining according to the historical behavior information to generate task label data in the task profile data.

9. The recommendation system according to claim 8, wherein the task profile building module performs classification calculation according to the task information and the task label data to build a task profile map in the task profile data and performs classification calculation according to the task label data to train and update the task profile building module, wherein the task profile map comprises structured data of a relationship between the task information and the task label data.

10. The recommendation system according to claim 1, wherein the profile matching module performs data annotation according to a user profile map in the user profile data, a task profile map in the task profile data, and the historical behavior information to generate user and task preference data and performs association analysis according to the user profile map, the task profile map, and the user and task preference data to build the profile knowledge map.

11. An operation method of a recommendation system, comprising:
storing a plurality of modules by a storage device, and accessing an enterprise database of an enterprise system, wherein the modules comprise a user profile building module, a task profile building module and a profile matching module; and
executing the modules by a processor, comprising:
performing data mining by the user profile building module and the task profile building module according to historical behavior information, user information, and task information in the enterprise database to generate user profile data and task profile data; and
performing data mining by the profile matching module according to the historical behavior information, the user profile data, and the task profile data to generate a profile knowledge map, so that when the enterprise system receives input information, the enterprise system obtains recommended data that matches the input information from the user profile data, the task profile data, and the profile knowledge map.

12. The operation method according to claim 11, wherein the profile knowledge map comprises structured data of a relationship between the user profile data and the task profile data.

13. The operation method according to claim 11, wherein the user profile data comprises user label data and a user profile map,
wherein the operation method further comprises:
storing the user label data in a first database by the user profile building module, so that the profile matching module accesses the first database; and
storing the user profile map in a second database by the user profile building module, so that the enterprise system accesses the second database.

14. The operation method according to claim 11, wherein the step of performing data mining according to the historical behavior information, the user information, and the task information in the enterprise database to generate the user profile data and the task profile data comprises:
performing log mining by the user profile building module according to the historical behavior information to generate user label data in the user profile data.

15. The operation method according to claim 14, wherein the step of performing data mining according to the historical behavior information, the user information, and the task information in the enterprise database to generate the user profile data and the task profile data comprises:
performing classification calculation by the user profile building module according to user basic information in the user information and the user label data to build a user profile map in the user profile data, wherein the user profile map comprises structured data of a relationship between the user information and the user label data.

16. The operation method according to claim 14, wherein the step of performing data mining according to the historical behavior information, the user information, and the task information in the enterprise database to generate the user profile data and the task profile data comprises:
performing classification calculation by the user profile building module according to user interest information in the user label data to train and update the user profile building module.

17. The operation method according to claim 11, wherein the task profile data comprises task label data and a task profile map,
wherein the operation method further comprises:
storing the task label data in a third database by the task profile building module, so that the profile matching module accesses the third database; and
storing the task profile map in a fourth database by the task profile building module, so that the enterprise system accesses the fourth database.

18. The operation method according to claim 11, wherein the step of performing data mining according to the historical behavior information, the user information, and the task information in the enterprise database to generate the user profile data and the task profile data comprises:
executing log mining by the task profile building module according to the historical behavior information to generate task label data in the task profile data.

19. The operation method according to claim 18, wherein the step of performing data mining according to the historical behavior information, the user information, and the task information in the enterprise database to generate the user profile data and the task profile data comprises:
performing classification calculation by the task profile building module according to the task information and the task label data to build a task profile map in the task profile data; and
performing classification calculation by the task profile building module according to the task label data to train and update the task profile building module, wherein the task profile map comprises structured data of a relationship between the task information and the task label data.

20. The operation method according to claim 11, wherein the step of performing data mining according to the historical behavior information, the user profile data, and the task profile data to generate the profile knowledge map comprises:
performing data annotation by the profile matching module according to a user profile map in the user profile data, a task profile map in the task profile data, and the historical behavior information to generate user and task preference data; and
performing association analysis by the profile matching module according to the user profile map, the task profile map, and the user and task preference data to build the profile knowledge map.
